(19) United States
(12) Patent Application Publication
(10) Pub. No.: US 2025/0378394 A1
(43) Pub. Date: Dec. 11, 2025

(54) System and Method for charting a plane

(71) Applicant: FlyHouse Technology, LLC, Van Nuys, CA (US)

(72) Inventors: Adesh DESAI, Chatsworth, CA (US); Deepak SODHI, Chatsworth, CA (US); Sanford L. MICHELMAN, Los Angeles, CA (US)

(21) Appl. No.: 18/658,530

(22) Filed: May 8, 2024

Related U.S. Application Data
(60) Provisional application No. 63/629,962, filed on May 12, 2023.

(51) Int. Cl. G06Q 10/02; G06Q 20/40; G06Q 30/08; G06Q 50/47

(52) U.S. Cl. CPC G06Q 10/02; G06Q 20/4014; G06Q 30/08; G06Q 50/47

(57) ABSTRACT

Embodiments of the invention described herein relate to efficient coordination and management of charter flight transportation. The Interface may include user interface, owner interface and service provider interface. The user interface may allow users to input user requirements, such as origin location, destination location, date/time of the trip, number of passengers, payment options, and preferred cost. The user requirements is used to begin a bidding process with the owners. Further, the owner interface allows owners to set certain parameters of bidding process. Further, the user may then select bid placed by owner and lowest bid may be winning bid. Further, the service provider interface similarly tracks the list of customers, list of owners, charter requests, completed trip details, aircraft information, pilot and crew information, and expense information. The service provider allows for generation of reports that contain this information. The service provider confirms booking and receive payment from user.

### CROSS-REFERENCE TO RELATED APPLICATIONS

This application claims the benefit of U.S. Provisional Application Ser. No. 63/629,962, filed on May 12, 2023, the entire content of which is incorporated herein by reference in its entirety.

### TECHNICAL FIELD

Embodiments of the inventions described herein relate to efficient coordination and management of charter flight transportation, in particular, to a computer system and associated mobile applications for both front-end and back-end management of charter flights.

### BACKGROUND

Charter flights offer more flexibility in terms of departure times, origin and destination location, and fewer connections and/or layovers. As a result, charter flights have become extremely popular, and private plane owners have entered the industry to fill this need. In the past, broker services have operated as a middleman to facilitate securing charter flights between individual plane owners and customers.

However, these services focused on the customer, dictating pricing and terms that may cause the plane owners to operate their planes at a loss especially when the fuel, pilot, crew, maintenance, hangar, landing, and other costs are considered.

Embodiments of the inventions solve these problems with a sophisticated set of front-end and back-end systems that facilitate a match between customers and plane owners based on a bid-ask process.

### SUMMARY

These inventive systems include a customer mobile application, an owner mobile application, and back-end databases, processors, and algorithms that enable aspects of the embodiments described below.

One embodiment relates to mobile applications for customers and plane owners. Both applications include a variety of user interfaces, one of which authenticates users. It may prompt a user to enter authentication details. The authentication details may include a phone number, an email ID, a username, a password, and a One Time Password (OTP). Further, the mobile applications may include interfaces for registering the user if the user is not already registered on the application. Further, the customer application may include interfaces that prompt the user to enter a charter request. The user may provide various charter details, such as a source location and a destination location, a number of passengers traveling, or a price the user is willing to pay. Alternatively, the customer re-book a previous plane or edit a request that has already been made. Once the back-end systems provide booking options of planes matching the customer's charter request, the customer application provides interfaces for viewing matching option details and selecting a plane from those options. The client application then provides interfaces to pay the booking amount and return a payment receipt and the booking confirmation to the customer.

The owner application may provide interfaces that allow the plane owner to view the customer's charter request (or portions thereof) so that the owner may bid on servicing that request. Alternatively, the owner may be notified through SMS or e-mail about the charter request. The owner may choose to participate in the bidding process by accepting the charter request, or the owner may opt out of the bidding process. The owner application allows plane owners to set a base rate, minimum rate, maximum rate, and other details to automate the bidding process if desired. As another option, the owner application allows the plane owner to manually participate in the bidding process. When a particular owner's bid is selected as the winning bid, the owner application provides interfaces that confirm selection of provide payment details.

Another embodiment relates to the back-end systems that facilitate the mobile applications, the bidding process, and payment. As one example, the back-end systems provide algorithms to match charter requests with at least one owner's plane based on the customer's desired user requirements. The back-end systems may also notify owners that match the charter request's user requirements so that they may participate in the bidding process if desired. The back-end systems then start the auction, and receive bids from one or more owners. Once the winning bid is selected, the back-end systems. may generate an e-agreement between the user and the owner for booking of the plane. Further, the service provider may assign a pilot and a crew to the booked plane.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary environment in which various embodiments for chartering a plane may function.

FIG. 2 illustrates a flow diagram of a process for a user to charter a plane, in accordance with some embodiments.

FIGS. 3A to 3J illustrate an exemplary user interface (UI) configured for interaction of a user for chartering a plane, in accordance with some embodiments.

FIG. 4 illustrates a flow diagram of a process for an owner to submit a bid to a request for chartering plane, in accordance with an embodiment.

FIGS. 5A to 5E illustrate an exemplary UI configured for interaction of an owner submitting a bid to a request for chartering a plane, in accordance with some embodiments.

FIG. 6 illustrates a flow diagram of a process of the service provider for chartering a plane.

FIGS. 7A to 7B illustrate exemplary methods for chartering the plane.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments.

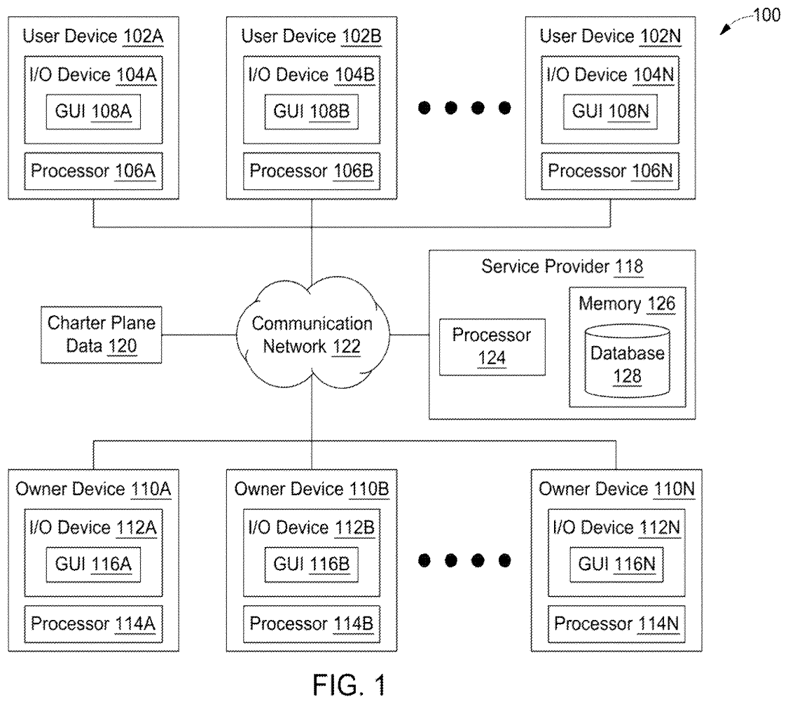

Referring now to FIG. 1, an exemplary environment 100 in which various embodiments for chartering a plane may function, is illustrated. The environment 100 includes one or more user devices, such as a user device 102A, a user device 102B, . . . , and a user device 102N. Further, each of the one or more user devices may include an Input/Output (I/O) device and a processor. For example, the user device 102A may include an I/O device 104A and a processor 106A, the user device 102B may include an I/O device 104B and a processor 106B, . . . , and the user device 102N may include an I/O device 104N and a processor 106N. Further, the I/O device 104A may include a GUI 108A, the I/O device 104B may include a GUI 108B, . . . , and the I/O device 104N may include a GUI 108N.

The environment 100 further includes one or more owner devices, such as an owner device 110A, an owner device 110B, . . . , and an owner device 110N. Each of the owner devices may include an I/O device and a processor, i.e., the owner device 110A may include an I/O device 112A and a processor 114A, the owner device 110B may include a I/O device 112B and a processor 114B . . . , and the owner device 110N may include a I/O device 112N and a processor 114N. Further, the I/O device may include a corresponding GUI i.e., the I/O device 112A may include a GUI 116A, the I/O device 112B may include a GUI 116B, . . . , and the I/O device 112N may include a GUI 116N.

Further, the environment 100 includes a service provider 118. The service provider 118 may be a server that may enable interaction between the one or more user devices and the one or more owner devices. The environment 100 includes various systems and sub-systems for displaying charter plane data 120 to users on the GUIs 108A, 108B, 108N via the service provider 118. The user devices (i.e., the user devices 102A, 102B, 102N), the owner devices (i.e., the owner devices 110A, 110B, 110N), and the service provider 118 may interact with each other via a communication network 122 for exchanging data. The communication network 122 may include any wired or a wireless network based on different communication technologies (for example, optical fibre, coaxial cable, Universal Serial Bus (USB), High-Definition Multimedia Interface (HDMI), satellite communication technology, television communication technology, WiFi, Worldwide Interoperability for Microwave Access (WiMAX), Wireless Local Area Network (WLAN), Bluetooth, mobile communication technologies, Internet, and so forth. As will be appreciated, the charter plane data 120 may include digital contents (for example, plane availability, time slots availability, etc.) that users may access through the service provider 118 on the GUIs 108A, 108B, 108N, of the respective user devices 102A, 102B, 102N.

The I/O devices 104A, 104B, 104N of the user devices 102A, 10B, 102N may enable the users to interact with the service provider 118, the charter plane data 120, and the owner devices 110A, 110B, 110N via the communication network 122. The I/O devices 104A, 104B, 104N may be configured to enable the users to provide user responses to the service provider 118 and receive an output (for example, owner responses) from the service provider 118 over the communication network 122. The users may provide the user responses and receive the output from the service provider 118 on the GUIs 108A, 108B, 108N of the I/O devices 104A, 104B, 104N. In an embodiment, the user devices 102A, 102B, 102N may include, but not limited to, a smartphone, a laptop, a digital device, a desktop, or any other handheld device. Further, the processors 106A, 106B, 106N may be configured to interpret the user responses and render output on the GUIs 108A, 108B, 108N of the I/O devices 104A, 104B, 104N to the users.

The service provider 118 may be a platform that may connect the user desiring to charter the plane with the owners of the planes. Further, the service provider 118 may include a processor 124 and a memory 126. The memory 126 may include a database 128 that may store the information of the users and the owners in an organized format. The database 128 may also store or retrieve the charter plan data 120 in real time via the communication network 122. Further, the processor 124 may execute the control logic saved in the memory 126 of the service provider 118 to match the user requirements with the owner proposals to charter the plane.

Further, the I/O devices 112A, 112B, 112N of the owner devices 110A, 110B, 110N may be configured to work similarly to the I/O devices 104A, 104B, 104N of the user devices 102A, 102B, 102N. In an embodiment, the owner devices 110A, 110B, 110N may enable the owners to interact with the service provider 118. In some embodiments, the owners may provide owner inputs and receive the user responses to/from the service provider 110 via the I/O devices 112A, 112B, 112N. The owners may provide plane details to the service provider 118, such as maximum number of passengers, range, tail number, and location. The service provider 118 may then match planes (and thus plane owners) to charter requests based on the charter request's user requirements.

It should be noted that, in the above embodiments, the service provider 118 may typically be located remotely with respect to the owner devices 110A, 110B, 110N, and the user devices 102A, 102B, 102N.

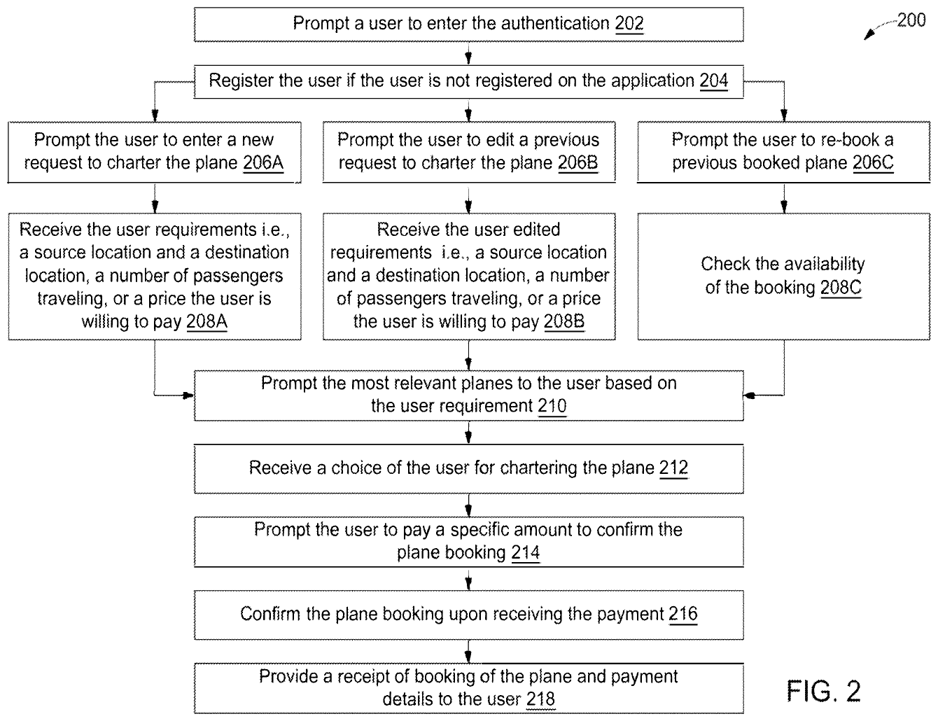

Referring now to FIG. 2, a process for a user to charter a plane from an owner through the service provider is depicted via a flow diagram 200, in accordance with some embodiments. FIG. 2 is explained in conjunction with FIG. 1. Each of the steps 202-218 may be performed through a UI of a user device. At step 202, a service provider (for example, the service provider 118) may prompt the user to enter authentication details (for example, user credentials). In response, the user may enter the authentication details to log into a service provider's platform (for example, an application). The authentication details may include, but are not limited to, a phone number, an email ID, a username, a password, and a One Time Password (OTP). The application may be a mobile application, a computer application, a website, or a web page.

At step 204, the service provider may register the user if the user is not already registered on the application. In some embodiments, the service provider may render a page of registration to the user when the user clicks on a registration button. In other words, when the user clicks on the registration button, the service provider may navigate the user to a registration page. Further, the user may be required to provide details shown on the registration page. Once the user provides the details and presses a corresponding enter button, the user may be registered on the service provider's platform or the application. In some embodiments, an option of continuing with an already logged in account on any other platform may be provided to the user to sign up in the current application associated with the service provider.

Further, the service provider may prompt a plurality of options for the user to charter a plane. The plurality of options may include, prompting the user to enter a new request to charter a plane, edit a previous request to charter a plane, or re-book a previously booked plane. At step 206A, the service provider may prompt the user to enter a new request to charter a plane. When the new request is entered, the service provider may receive user requirements at step 208A. The user requirements may include a source location and a destination location, a number of passengers traveling, or a price the user is willing to pay.

At step 206B, the user may edit a previous charter request when desired. When the user elects to edit a previous request, at step 208B, the service provider receives those edited user requirements. For example, the service provider may receive one or more of an edited source location and an edited destination location, an edited number of passengers traveling, or an edited price the user is willing to pay. Alternatively, at step 206C, the user may decide to re-book a previously booked charter plane. In response, at step 208C, the service provider may determine if the previously booked charter plane is available as per the user requirements.

Thereafter, at step 210, the service provider may provide a listing of the most relevant planes to the user based on the user's requirements. The listing may include the user specified planes and the best deals for the user. At step 212, the service provider may receive a choice of plane from the user. In other words, the user may select a plane from the listing. At step 214, the service provider may prompt the user to pay a specific amount to confirm booking of the selected plane. At step 216, the service provider may confirm the booking of the charter plane upon receiving the payment. Finally, at step 218, the service provider may provide a receipt of booking of the charter plane and the payment details to the user.

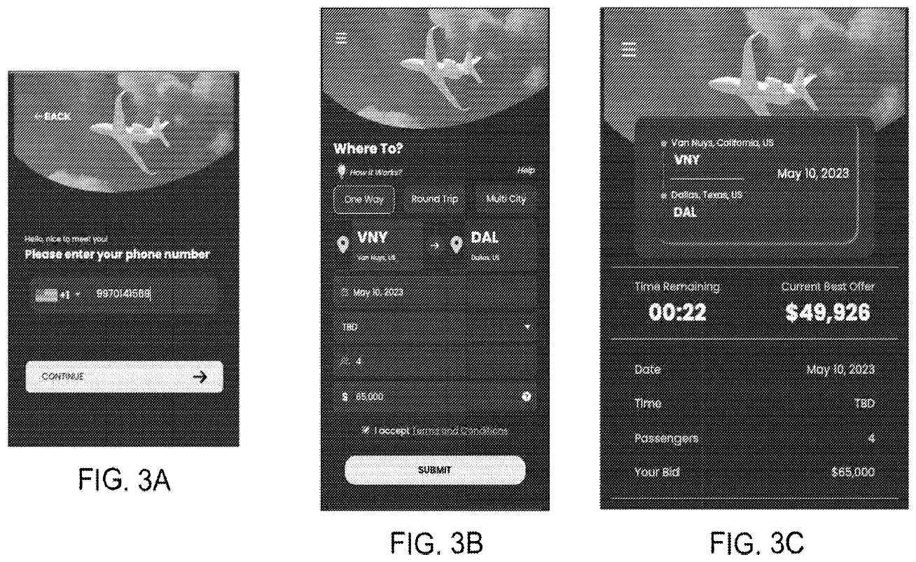

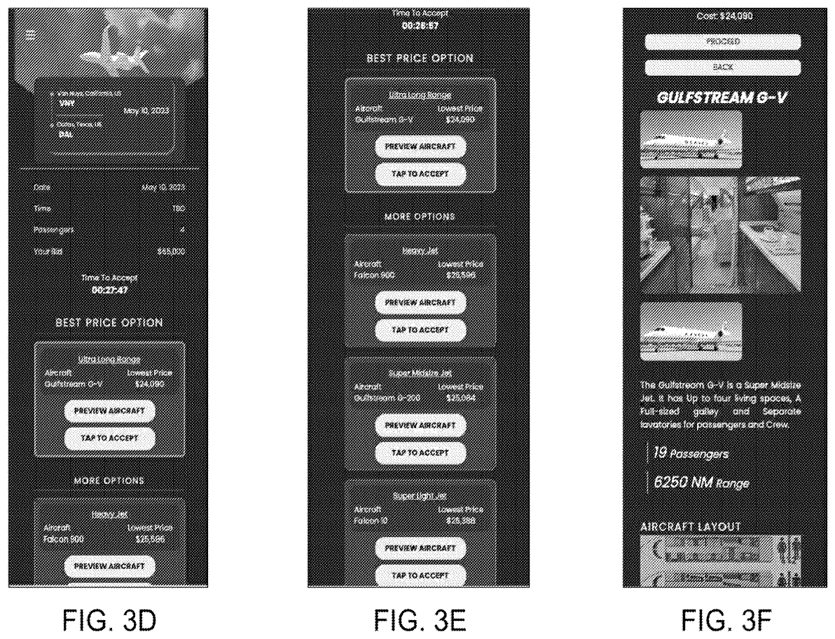

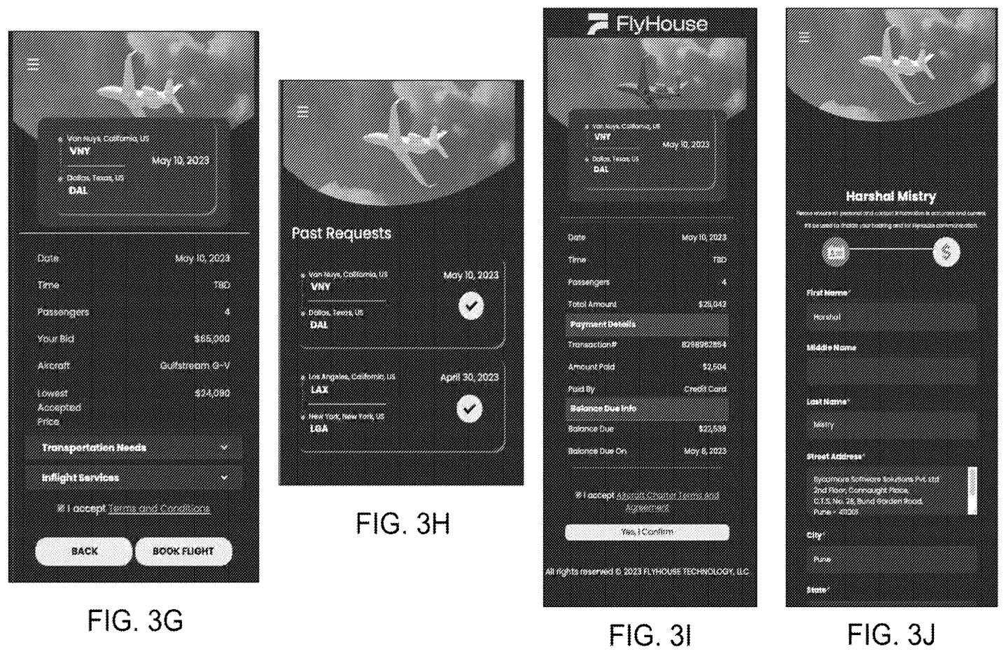

Referring now to FIG. 3A to FIG. 3J, an exemplary set of user interfaces (UIs) configured for interaction of a user for chartering a plane is illustrated, in accordance with some embodiments. FIGS. 3A-3J are explained in conjunction with FIGS. 1-2. In FIG. 3A a login page is illustrated. The login page may be rendered to the user on the UI. The login page may include various components including a prompt box that a user may use to login to an application associated with the service provider. In this embodiment, there are two sections in the prompt box, a first section for selecting a country code and a second section for entering a phone number. The user may be required to choose the country code in the first section and provide the phone number in the second section of the prompt box as an authentication detail. For example, in some embodiments, the user may select the country code as “+1” and enter the phone number as “9970141569”. After entering authentication details, the user may click on a continue button to log into the application successfully. In FIG. 3B, a new request interface of a customer application is illustrated. Upon successful login to the application, the user may be navigated to the new request interface when the user chooses to enter a new request. Here the user may be able to enter user requirements to charter a plane. For example, the components may include a box for selecting a number of passengers, a box for selecting a source location, a box for selecting a destination location, a box for selecting a date, a box for adding a price, and a box for selecting a preferred aircraft. The UI may also allow the user to select different types of trip, such as a one way trip, round trip, or a multi city trip. The prompt boxes may be drop down menus and/or may allow for direct text entry.

Further, in FIG. 3C, a preview page is illustrated. In one embodiment, the preview page may be rendered to the user when requested. In another embodiment, the preview page may be opened once the user enters the user requirements and presses an enter button. The preview page may include a timer component that may indicate the remaining time for the plane owners to place the bids for the user requested flight. The preview page may also include trip details as selected by the user. In FIGS. 3D and 3E, available planes that meet or exceed the user requirements may be rendered to the user through the UI. The UI shows the available planes along with an option to preview plane features and the prices offered by the owners for the available plane. By way of an example, the user requirements in FIG. 3D include the source location “Van Nuys, California, US”, the destination location “Dallas, Texas, US”, the date “May 10, 2023”, the number of passengers “4”, and the expected price “$65,000”. This page also includes a best price option and more options for matching planes. Here, the available planes rendered to the user may include an ultra-long range aircraft with model “Gulfstream G-V” and lowest price “$24,090”, a heavy jet aircraft with model “Falcon 900” and lowest price “$25,596”, a super midsize jet aircraft with model “Gulfstream G-200” and lowest price “$25,084”, and a super light jet aircraft with a model “Falcon 10” and lowest price “$26,388”. Each aircraft option allows the user to preview the aircraft by selecting “preview aircraft” and or accept the bid by selecting “tap to accept”. The UI may also render a resubmission button which the user may use to proceed with resubmitting a selected plane or a choice of plane.

In FIG. 3F, a preview page displaying information of the selected plane (selected by the user) on the UI is illustrated. For example, the user may have clicked on the “preview aircraft” button corresponding to the ultra-long range aircraft with the model “Gulfstream G-V” and the lowest price “$24,090”. The preview page may include images of the selected plane and a short summary of the selected plane. In this example, the short summary states “The Gulfstream G-V is a Super Midsize Jet. It has up to four living spaces, a Full-sized galley and separate lavatories for passengers and crew”. The preview page may also include information of the capacity of the selected plane (for example, 19 passengers), a range of the plane (for example, 6250 NM range), and a layout of the selected plane. The preview page may also include a button to accept the offer proposed by the owner for the previewed plane. Also, the preview page includes a back button. The user may be able to see all the options of the aircraft again when the user clicks on the back button.

A preview of the accepted offer is illustrated in FIG. 3G. The UI displays the preview including user provided details (such as, the source location “Van Nuys, California, US”, the destination location “Dallas, Texas, US”, the date “May 10, 2023”, the number of passengers “4”, and the expected price “$65,000”), and the details of the accepted offer (such as the model of the selected aircraft “Gulfstream G-V, and the lowest price $24,090). The UI may also render a plurality of drop-down prompts for additional services including transportation needs (i.e., Yes), and inflight services (i.e., Yes).

In FIG. 3H, the customer application may also render past trip requests (made by the user to charter a plane) of the particular logged in customer. The UI may include past trips in the form of clickable tabs which may include the source and destination of the trip and the date of the trip. By way of an example, one recent past request includes a destination location “Van Nuys, California, US”, a destination location “Dallas, Texas, US”, and a date “May 10, 2023”, By way of another example, one past request includes the source location “Los Angeles, California, US”, a destination location “New York, New York, US”, and a date “Apr. 30, 2023”.

FIG. 3I, illustrates a payment a payment interface. The UI may display information related to the trip details, such as a time duration of the trip, a distance traveled in the trip, date of the trip (for example, May 10, 2023), the number of passengers (i.e., 4 passengers), and the aircraft chosen by the user (for example, the model “Gulfstream G-V”), and various payment details, including amount paid to date ($2,634), the transaction number and how the payment was made (e.g., by credit card), balance due and the deadline to submit the balance.

FIG. 3J illustrates an account detail interface. The UI allows the user to view, enter, or change the account information, such as name, address, and contact information, such as an email address, a phone number, etc.

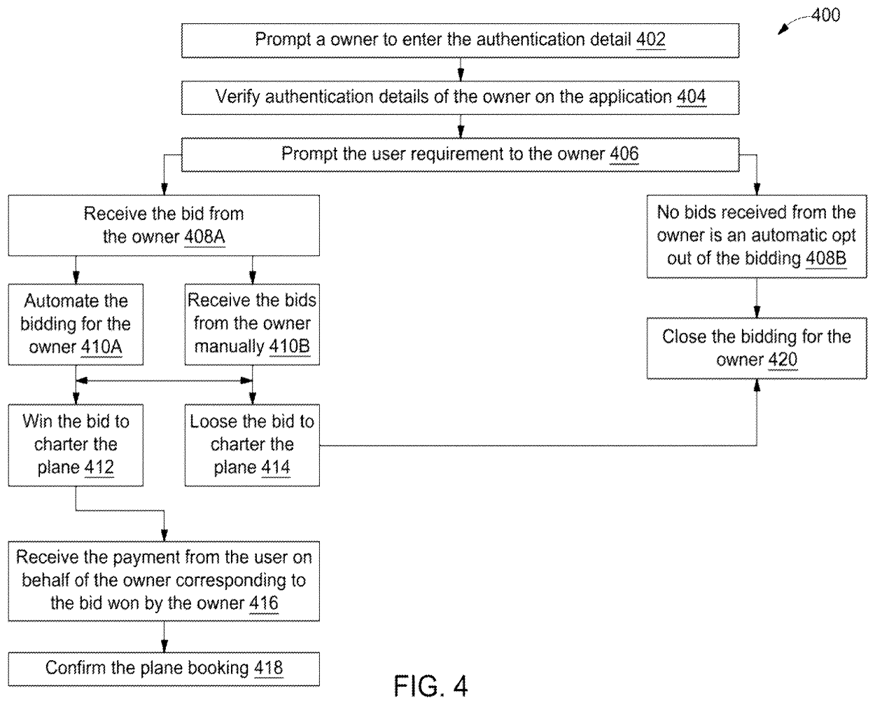

Referring now to FIG. 4, an exemplary process 400 for a plane owner to bid on charter request(s) related to his/her plane is illustrated. FIG. 4 is explained in conjunction with FIG. 1-3. Each of the steps 402-420 may be performed through a UI of an owner device. At step 402, a service provider may prompt the owner to enter authentication details (for example, owner credentials) within an owner application. In response, the owner may enter authentication details, which may include, but are not limited to, a phone number, an email address, a user name, a password, and/or a One Time Password (OTP). As already explained, the application may be a mobile application, a computer application, a website, or a web page. At step 404, the authentication details of the owner may be verified on the application.

In some embodiments, the service provider may initiate a registration process if the owner is not already registered on the application. In some embodiments, the service provider may render a page of registration to the owner when the owner clicks on a registration button. In other words, when the owner clicks on a registration button within the owner application, the service provider may navigate the owner to a registration page. Once the owner provides registration details—such as a username, password, and contact information—and presses a corresponding enter button, the owner may be registered on the service provider's platform or the application.

At step 406, the service provider may provide the user requirements/edited user requirements to the owner once the authentication details of the owner are verified. The user requirements may include a source location and a destination location, a number of passengers traveling, or a price the user is willing to pay as noted above. In some embodiments, the service provider may send a bid notification to the owner about the user requirements through a short messaging service (SMS) or e-mail, when the service provider finds the owner capable of meeting the user requirements. The owner may choose to bid or not based on the user requirements or other factors like blackout dates when the plane is unavailable. If the owner chooses to bid, at step 408A, the service provider may receive a response that the owner is willing to bid. The owner may choose to bid automatically or may choose to bid manually. In an embodiment, if the owner chooses to bid automatically, at step 410A, the service provider may automate the bids for the owner. In another embodiment, if the owner chooses to bid manually, at step 410B, the service provider may receive manual the bids from the owner.

At step 412, the owner may win the bid when the user accepts that owner's particular bid. Once the owner wins the bid, at step 416, the service provider may receive a payment from the user on behalf of the owner corresponding to the bid. At step 418, the service provider may confirm the chartering of the plane for the respective user. Alternatively, at step 414, the owner may lose the bid. At step 420, the service provider may close the bidding for the owner. In another embodiment, if the owner chooses to reject the bidding, at step 408B, the service provider may receive no response from the owner. This is treated as a rejection from the owner to opt out of the bidding. Subsequently, at step 420, the service provider may close the bidding for the owner.

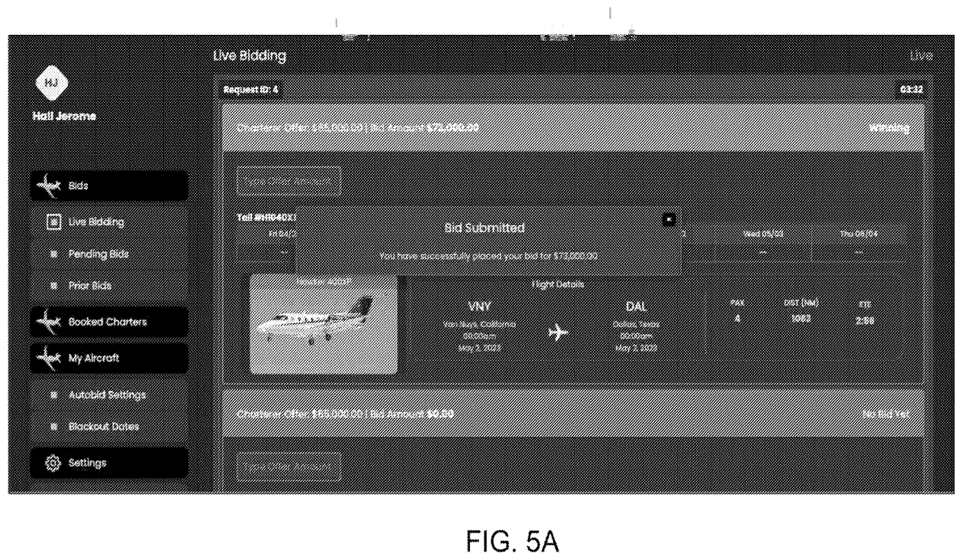

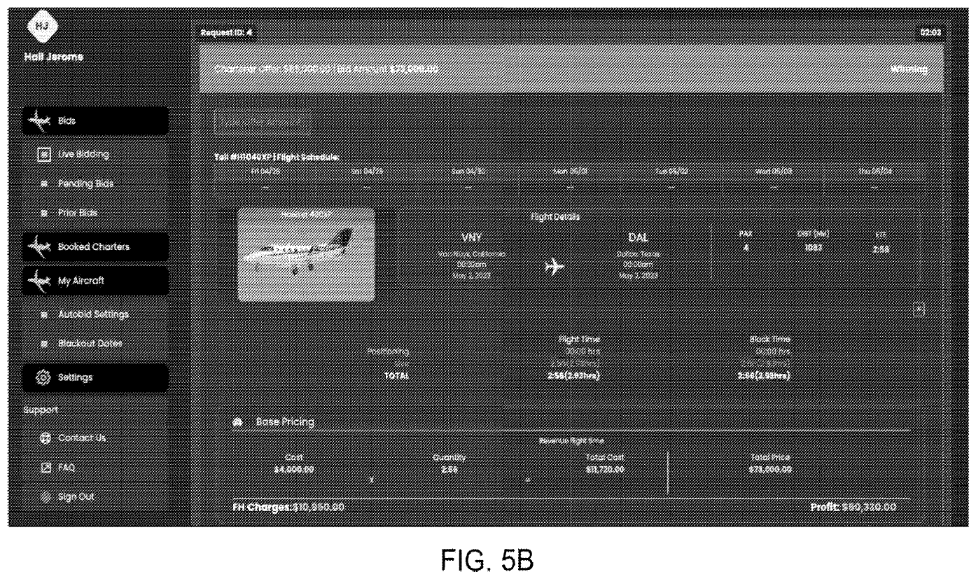

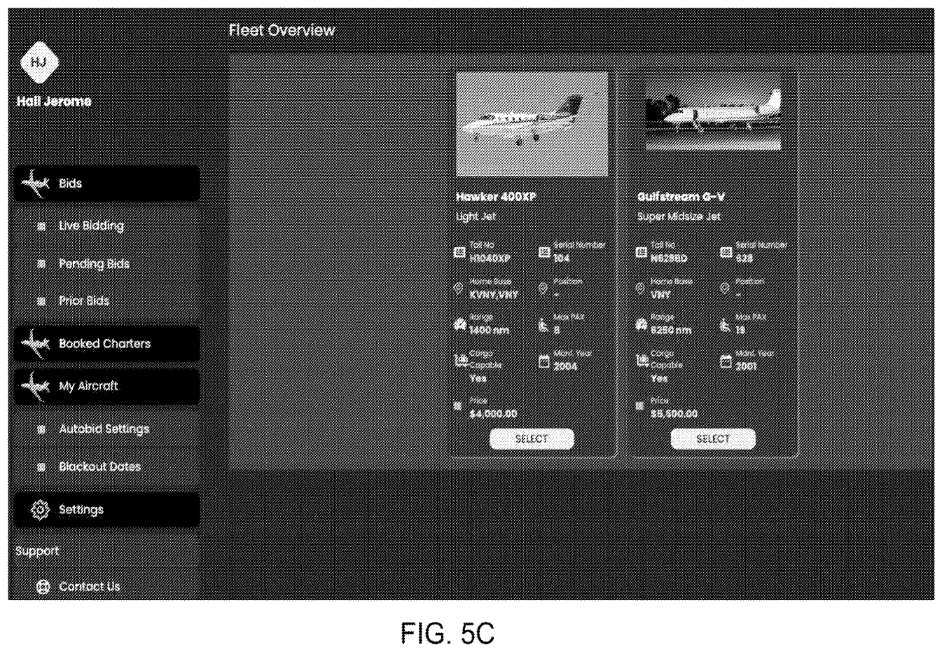

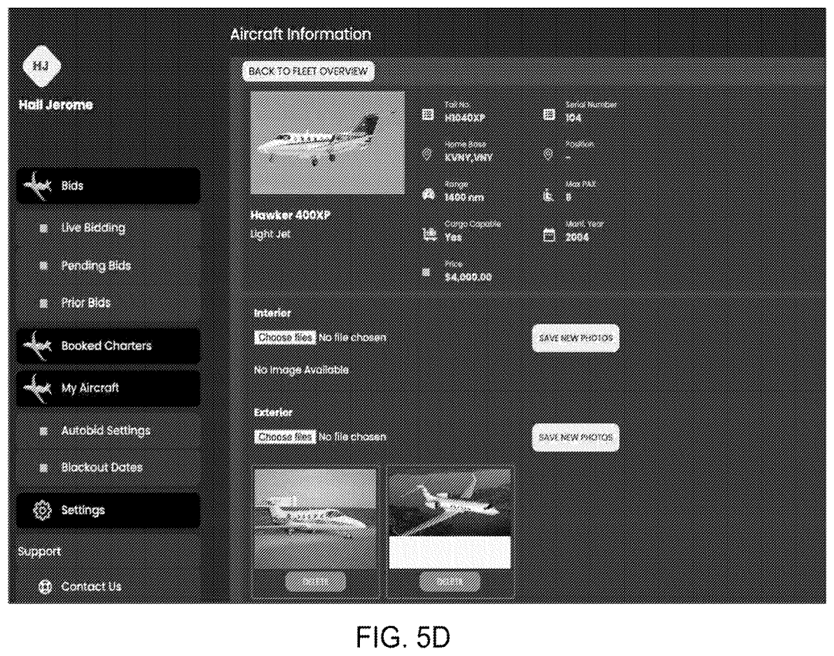

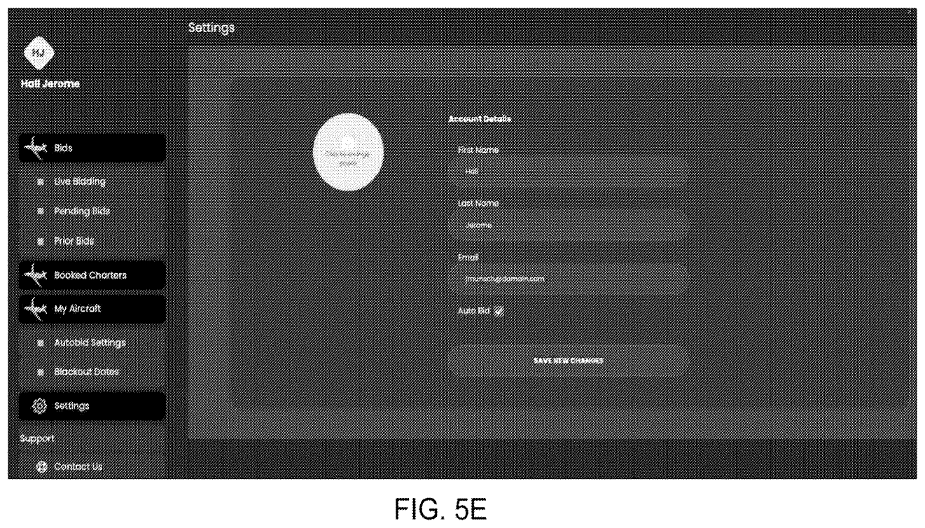

Referring now to FIG. 5A to FIG. 5E, an exemplary set of UIs for the owner application are illustrated. FIGS. 5A-5E are explained in conjunction with FIGS. 1-4. It should be noted that the login and registration process for the owner on a service provider's platform (i.e., an application) may be similar to the login and registration process of the customer. The service provider may render a bid panel to the owner on the UI of an owner device, as illustrated in FIG. 5A. The UI displays the bidding panel where the owner may provide bidding details corresponding to the plane. For example, the owner may enter a bid price (e.g., Bid Amount $73,000) for the plane. The bidding panel includes a user preferred price (e.g., Charterer Price $65,000), and the particular user requirements including source location, destination location, starting and ending date and time of trip, and the like as set forth above.

In FIG. 5B, an exemplary owner application after winning a bid is illustrated. The owner application may display the number of owners participating in the auction, and charter request details, including source location, destination location, number of passengers, the start date, and the end date. The owner application may also display pricing details, including a base pricing calculator. The pricing calculator may include the hourly charge of the flight, hangar charges, and other costs. The owner application may also calculate the total cost, total price, and total profit for the winning bid.

In FIG. 5C, an exemplary fleet overview UI associated with the owner application is illustrated. The UI may display the details of the planes listed by the owner. The details of the plane(s) may include the images of the plane, location of the plane, range of the plane, minimum cost of the plane, maximum cargo and passenger capacity, and year of manufacture. The owner may also edit the details of the planes via an edit tab.

In FIG. 5D, an exemplary detailed aircraft interface of the owner application is illustrated. The UI may display the details of the plane and allow the owner to edit the aircraft details, including the name, model, home base, tail number, serial number, range, maximum passenger and capacity, year of manufacture, photos, and relevant auto bidding details (e.g., the price used in the bidding calculator. The owner may also save the blackout dates for the plane.

In FIG. 5E, an exemplary account detail UI of the owner is illustrated. The account detail UI displays the account details of the owner. The account details may include, the name of the owner, a photo, an email, etc. The owner may also set the auto bid to ON/OFF for participating in the auction.

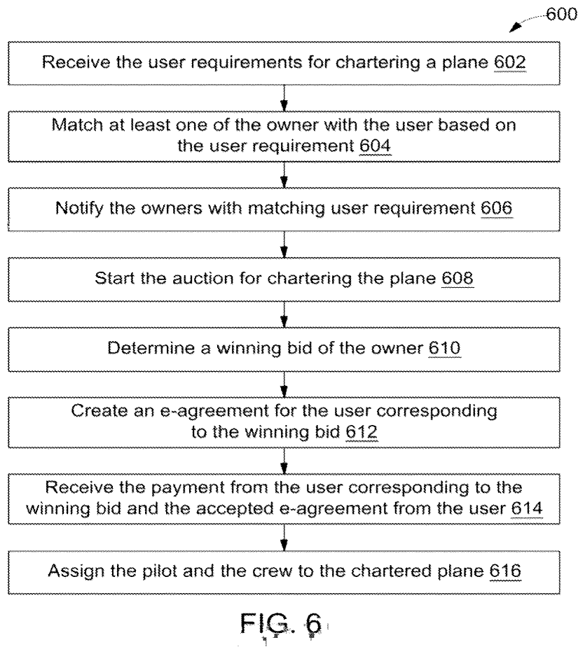

Referring now to FIG. 6, a flow diagram of an exemplary process of the service provider 110 for chartering a plane is illustrated. At step 602, the service provider 110 receives the user requirements from the customer's charter request. At step 604, at least one plane owner may be matched with a customer based on the user requirements.

At step 606, plane owners that have least a partial match the user requirements may be notified. At step 608, the auction may be started for chartering a plane. The owners may place their bids and the user may select an offered bid. Then, at step 610, a winning bid is determined. The winning bid is determined by the service provider 110 or the customer.

At step 612, an e-agreement may be created for the user corresponding to the winning bid. The e-agreement may include the booking details and the payment details of the chartered plane. Further, at step 614, the payment may be received from the user corresponding to the winning bid and the e-agreement may be accepted by the user. At step 616, the pilot and the crew may be assigned to the chartered plane.

In some embodiments, the bidding process may be automated for the owner. The owners may need to specify a plurality of parameters in order to automate the bidding process. The plurality of parameters may include a base rate, a minimum rate, a starting rate, and a decrement percentage. The base rate may be used to calculate the repositioning charges in the bid. The minimum rate may be a lowest price at which the bidding will end for the owner (for example, the owner may never bid less than the minimum rate.). The starting rate may be a price at which the bidding may start unless at least one of: the user preferred price is higher than the starting rate, or the auction bid is higher than the starting rate. The decrement percentage may be the amount adjusted downward for subsequent auto bids. The bid may decrease at a pre-determined time interval based on the decrement percentage set by the owner.

Further, the auto bidding may follow a process as explained below in greater detail. In an embodiment, the processor 124 of the service provider 110 may execute auto bidding for the owner using the control logic saved in the memory 126. The control logic for auto bidding may be as explained:
IF Bid Amount>=Maximum Rate:
   Bid based on Maximum Rate.
ELSEIF Bid Amount>Minimum Rate:
   Use the Decrement Percentage to calculate Bid amount.
   Verify the Bid Amount is>=Minimum Rate amount and make the bid
      If it computes to be less than the Minimum Rate, then bid based on the Minimum rate.
   ELSE:

The bid is lower than the Minimum rate, so the bid may not be submitted.

In some embodiments, the service provider 110 may also calculate the total flight time and potential revenue for the owner. The service provider 110 may create data sheets for revenue versus the cost calculation based on the owner decided rates. The owner may also review his/her past bids and analyze the winning or losing bids.

In some embodiments, the service provider 110 may add/edit pilot details, including the capabilities of the pilot. The service provider 110 may also review the list of past auctions, completed tips, registered owners, and registered users. The service provider 110 may also maintain the customer interface and owner interface for smooth functioning. The service provider 110 may also manage the finances for the owners i.e., tax calculations, profit calculations, trip routes, etc. The service provider 110 may also provide monthly summary sheets to each of the registered owners. The monthly summary sheets may include profit made, flights booked in a month, revenue generated, and other cost, profit, and revenue calculations.

In some embodiments, the service provider 110 may assign a pilot and the crew to the booked flight after the auction is over. The service provider 110 may choose a pilot from the database according to the needs expressed in the user requirements and/or plane specifications. Further, the service provider 110 may edit the cost corresponding to the pilots and the crew for the booked flight. The service provider 110 may also keep a record for payments received from the user and the payments sent to the owners. The payment details may include type and date of the payment receipt, payment confirmation number, contact number, etc. The service provider may also keep the record for the cost associated with the amenities and the additional services opted by the user i.e., in flight food and beverages, transportation, fuel charges, any discount offered to the users, etc. the service provider 110 may also auto send the e-agreement to the user which may include all the trip details, payment details and the pilot and crew details.

Further, the service provider 110 may charge a commission from the auction as a service fees. The service fees may be deducted from the auction revenue. In one embodiment, the profit made by the owner may be calculated as charter auction revenue—service provider service fees—expenses incurred to operate the plane. The expenses for operating the plane may include a ground handling charge, infrastructure security/fees, parking fees, APHIS fees, INS fees, and customer user fees.

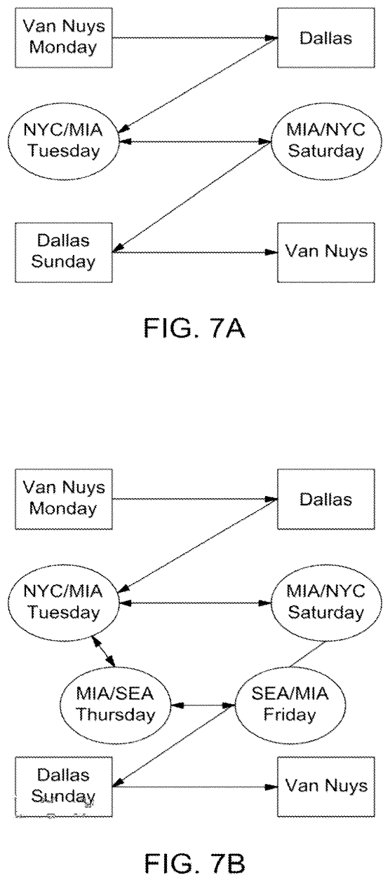

Referring now to FIGS. 7A and 7B, exemplary methods for chartering the plane are illustrated. In one embodiment, the booked charter plane may be available in between dates of the booking (for example, the plane may be available for between an existing booking of say Monday and Saturday). FIG. 7A illustrates a booking of trip in between an existing round trip. The plane may be booked from the source Van Nuys on Monday and destination as Dallas, and the return trip may be scheduled on Sunday from Dallas to Van Nuys. Therefore, the plane may be available between Tuesday and Saturday. So, the service provider may book the plane for another round trip that may fall in between the available dates for the plane. In this case, a round trip from NYC to MIA on Tuesday and MIA to NYC on Saturday has been booked. The charges for the in between trip may be calculated as the base rate from Dallas to NYC+Normal rate from NYC to MIA to NYC+base rate from NYC to Dallas.

In FIG. 7B, another booking between a round trip is illustrated. FIG. 7B has been explained in conjunction with FIG. 7A. Upon booking a trip in between a round trip, the service provider 110 may further book a trip in between Wednesday to Friday, such as a round trip between MIA to SEA on Thursday and Friday.

In some embodiments, the user may book a series of one-way trips. By way of an example, the user may specify a first trip including a source location, destination location and date of the trip. For each consecutive flight, the user may need to specify a destination airport and a date of trip. In some embodiments, the chartered plane may be considered unavailable upon successful booking by the user. Alternatively, the plane may be available for the any in-between flight.

As will be also appreciated, the above described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

It will be appreciated that, for clarity purposes, the above description has described embodiments of the invention with reference to different functional units and processors. However, it will be apparent that any suitable distribution of functionality between different functional units, processors, or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

The specification has described the system and method for chartering a plane. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

What is claimed is:

1. A computer-implemented system for management of charter flight transportation, comprising:
a customer mobile application accessible to charter flight customers for requesting and booking charter flights;
an owner mobile application accessible to plane owners for bidding on customer requests and managing plane details; and
a back-end application for coordinating bidding and scheduling charter flight operations associated with winning bids.

2. The computer-implemented system of claim 1, wherein the back-end application further comprises a payment processing module for handling booking payments and refunds.

3. The computer-implemented system of claim 1, wherein the customer mobile application receives charter flight requests comprising a source location, a destination location, a date range, and a number of passengers traveling.

4. The computer-implemented system of claim 2, further comprising a bid facilitator to receive the charter flight requests from the customer mobile application, receive bids from one or more owner mobile applications, and select relevant bids.

5. The computer-implemented system of claim 1, wherein relevant bids are selected based on a match between one of more of a source location destination location, number of passengers, date range, and price between the charter flight requests and owner bids.

6. A mobile application for managing charter flights, comprising:
a registration interface for plane owners to register with the application;
an aircraft interface for owners to enter plane details, including at least one of a tail number, plane type, photograph, maximum passenger load, and maximum range;
a bid interface to provide bid parameters, including at least one of a minimum bid threshold, blackout dates, and manual bid option; and
an account interface for owners to enter account details for receiving payment from acceptance of winning bids.

7. The mobile application of claim 6, wherein the registration interface further comprises an owner detail interface for providing an owner name, email address, cell phone number, and password.

8. The mobile application of claim 6, further comprising an authentication interface for owners to authenticate themselves through at least one of a phone number, an email ID, a username, a password, and a One Time Password (OTP).

9. The mobile application of claim 6, further comprising a winning bid interface for owners to view winning bid details, including at least one of a source location, a destination location, a number of passengers, a date range, and an agreed price.

10. A mobile application for managing charter flights, comprising:
a registration interface for users to register with the application;
a customer request interface for users to enter a request for a charter, where the request includes a source location, a destination location, a number of passengers, a date range, and a target price;
an auction interface to monitor an auction for charter plane owners to bid on the charter request;
a result interface to display a listing of bids from which users select a winning bid; and
a booking interface for users to accept and pay for the winning bid.

11. The mobile application of claim 10, further comprising a payment interface for users to enter payment details, including at least the selection of one or more stored credit cards, Apple Pay, Google Pay, or entry of new credit card details.

12. The mobile application of claim 10, wherein the registration interface further comprises a customer detail interface for providing a customer name, email address, cell phone number, and password.

13. The mobile application of claim 110, further comprising an authentication interface for customers to authenticate themselves with at least one of a phone number, an email ID, a username, a password, and a One Time Password (OTP).

14. The mobile application of claim 10, wherein the auction interface comprises at least one of a source location, a destination location, a date, a time remaining, and a current best offer.

15. A method for management and coordination of charter flight transportation, comprising:
receiving a charter flight request with user requirements from a customer application;
matching at least one available plane based on the charter flight request;
notifying an owner of the matched plane of the charter flight request via an owner application;
starting an auction for the charter flight request;
receiving at least one bid from at least one matched plane owner;
determining a winning bid based on price and availability;
assigning the requested charter flight to the winning bid; and
providing a summary of the booked charter flight request comprising a payment receipt and a booking confirmation to the customer application.

16. The method of claim 15, comprising the additional step of providing a summary of the booked charter flight details, including at least a payment receipt and booking confirmation, to the owner application.

17. The method of claim 15, wherein the step of receiving a charter flight request further comprises the step of:
entering a source location, a destination location, a number of passengers traveling, a date range, and a price requirement into the customer application.

18. The method of claim 15, comprising the additional steps of:
registering a customer through the customer application; and
registering an owner through the owner application.

19. The method of claim 15, comprising the additional step of:
entering payment details into the customer application, the payment details including at least one of a credit card number, a selection of Apple Pay, a selection of Google Pay, and a selection of a previously stored credit card.

20. The method of claim 15, comprising the additional step of:
selecting, by the matched plane owner, an autobid option at the owner application.

21. The method of claim 18, wherein the step of selecting an autobid option further comprises the steps of:
bidding at a maximum rate set by the plane owner if the charter flight request includes a bid amount equal to or greater than the maximum rate;
electing not to submit a bid if the bid amount is lower than a minimum rate set by the plane owner;
determining a decrement percentage if the bid amount is greater than the minimum rate and less than the maximum rate; and
bidding at a decremented rate between the minimum rate and maximum rate if the bid amount is between the minimum rate and maximum rate.
